(19) United States
(12) Patent Application Publication
(10) Pub. No.: US 2025/0139185 A1
(43) Pub. Date: May 1, 2025

(54) System for Facilitating Discovery and Acquisition of Micro-Credentials via a Browser Extension

(71) Applicant: Douglas Brian Wallace, Toronto (CA)

(72) Inventor: Douglas Brian Wallace, Toronto (CA)

(21) Appl. No.: 18/623,404

(22) Filed: Apr. 1, 2024

Related U.S. Application Data
(60) Provisional application No. 63/593,297, filed on Oct. 26, 2023.

(51) Int. Cl. G06F 16/955; G06F 16/958; G09B 7/00

(52) U.S. Cl. CPC G06F 16/955; G06F 16/986; G09B 7/00

(57) ABSTRACT

A system for micro-credential opportunity discovery and earning via an installed browser extension. The system includes a server equipped with a processor and a memory that executes a micro-credential browser extension within a web browser environment. This extension is designed to dynamically scan web pages accessed via the browser, utilizing a comparison between the web page's URL and a database to detect embedded micro-credential opportunities unique to each URL. Upon detecting a micro-credential earning opportunity, the system automatically generates a user notification within the browser, presenting an opportunity to engage with specific content or actions that satisfy criteria for earning the micro-credential. The system further monitors user actions to confirm criteria completion and issues a digital badge as a verifiable record of the micro-credential. The system enhances the process of discovering and acquiring digital credentials, making it more efficient and verifiable, thereby facilitating learning and skill verification.

### CROSS REFERENCE TO RELATED APPLICATION

This application claims the benefit of U.S. provisional application No. 63/593,297 filed on Oct. 26, 2023. The above identified patent application is herein incorporated by reference in its entirety.

### BACKGROUND OF THE INVENTION

The present invention relates to digital badges as representations of earned digital credentials. The present invention provides a system for facilitating the discovery and earning of a micro-credential via a browser extension.

In the rapidly evolving digital landscape, the acquisition of digital credentials, particularly micro-credentials that signify the completion of specific tasks or learning activities, has become increasingly important for individuals seeking to showcase their skills and achievements. Micro-credentials, often represented as digital badges, provide a versatile and scalable way to recognize and verify individual accomplishments beyond traditional education certificates. Despite their growing relevance, the process of discovering and earning these credentials remains encumbered by several limitations within existing systems.

The current state of the art primarily involves platforms or Learning Management Systems (LMS) that offer digital badges as part of structured learning programs. These systems are designed to award badges upon the completion of predetermined courses or activities within the confines of the platform. While effective to a degree, this approach severely restricts the scope of learning and earning opportunities to activities that are directly controlled and offered by the issuing platform. Consequently, learners and badge earners are confined to a relatively narrow set of opportunities, limiting the potential for broader engagement with diverse learning materials and activities across the internet.

Moreover, existing systems lack the flexibility to dynamically identify and capitalize on micro-credential opportunities outside of the structured environments provided by specific websites or platforms. This limitation not only constrains the accessibility of learning opportunities but also impedes the recognition of informal or self-directed learning activities that occur outside traditional platforms. As a result, many valuable learning experiences go unrecognized, and the potential for lifelong learning and skill development is not fully realized.

Furthermore, the process of earning and managing digital badges in existing systems often involves manual verification steps and lacks integration with broader digital ecosystems. This can lead to inefficiencies and delays in the recognition of achievements, diminishing the value of micro-credentials as immediate and verifiable tokens of accomplishment. Additionally, the isolated nature of these systems hampers the portability and sharing of credentials across different platforms and social networks, limiting their visibility and impact.

Therefore, there exists a need for a micro-credential opportunity discovery and earning system via a browser extension that transcends the limitations of traditional platforms. The problem the present invention addresses is allowing remote users to earn micro-credentials or rewards, regardless of whether the website offers a rewards, through a system configured to interact with the website. The system then publishes these verified rewards on a network or internet for others to view. By enabling the dynamic identification and earning of micro-credentials across a wide array of web environments, the invention significantly broadens the landscape of learning opportunities. It leverages advanced scanning and verification technologies to seamlessly integrate learning activities with the earning of digital badges, thus recognizing a wider range of learning experiences. Moreover, the system enhances the portability and visibility of credentials, facilitating their verification and sharing across digital spaces.

In light of the devices disclosed in the known art, it is submitted that the present invention substantially diverges in design elements and methods from the known art and consequently it is clear that there is a need in the art for an improvement for a system and process for micro-credential opportunity discovery and earning via browser extension. In this regard the instant invention substantially fulfills these needs.

### SUMMARY OF THE INVENTION

In view of the foregoing disadvantages inherent in the known types of systems and methods for micro-credential opportunity discovery and earning via browser extension now present in the known art, the present invention provides a system and method wherein the same can be utilized for discovering and earning micro-credentials via a browser extension.

It is an objective of the present invention to provide a system for micro-credential opportunity discovery and earning via browser extension comprising a server having a logic operably connected thereto, wherein the server adapted to host a website having a Uniform Resource Locator (URL). A micro-credential browser extension within a web browser environment, where the browser extension is configured to interact with the website accessed through a user computing device and based on the URL. The logic is configured to perform a method for earning a micro-credential via the micro-credential browser extension, comprising; searching a currently accessed website for an embedded micro-credential earning opportunity, via a comparison between the URL of the website and a pre-populated database within the system that correlates a URL with specific micro-credential earning opportunity, wherein each micro-credential is linked to a distinct criterion from a set of criteria for earning the micro-credential; generating and displaying a notification within the web browser upon detection of the micro-credential earning opportunity; monitoring actions received form the user computing device within the website to confirm completion of the criteria required for the micro-credential, leveraging data capture and analysis techniques to validate a user engagement; issuing a digital badge to a user's digital portfolio upon verified completion of the micro-credential criteria, the digital badge acting as a verifiable record of the micro-credential.

It is an objective of the present invention to offer a system for micro-credential opportunity discovery and earning via browser extension, which broadens the accessibility of micro-credential earning opportunities beyond traditional learning management systems. By integrating with a web browser, the system dynamically identifies learning and credentialing opportunities across various online platforms, thereby expanding the horizons for learners and professionals to acquire and demonstrate new skills and achievements.

It is an objective of the present invention to provide a system for micro-credential opportunity discovery and earning via browser extension that automates the process of earning digital badges. The system streamlines the identification, engagement, and verification of micro-credential earning activities, thus simplifying the user's journey from discovery to acquisition of credentials. This automation enhances the efficiency of credential earning, making it more user-friendly and accessible.

It is an objective of the present invention to offer a system for micro-credential opportunity discovery and earning via browser extension that ensures the verifiability and portability of digital badges earned through the system. By verifying achievements, the system guarantees the integrity and authenticity of credentials, facilitating their acceptance and recognition across various platforms and professional networks.

It is an objective of the present invention to provide a system for micro-credential opportunity discovery and earning via browser extension that fosters a culture of continuous learning and professional development. By making micro-credentials more accessible and verifiable, the system encourages individuals to engage in lifelong learning activities, thereby contributing to their personal and professional growth.

It is an objective of the present invention to introduce a system for micro-credential opportunity discovery and earning via browser extension that enhances the visibility of micro-credentials. By enabling the easy sharing of digital badges across social media and professional networking sites, the system increases the visibility of the user's achievements, thus amplifying the value of the credentials in showcasing skills and competencies to potential employers or clients.

It is therefore an object of the present invention to provide a new and improved system and method for micro-credential opportunity discovery and earning via browser extension that has all of the advantages of the known art and none of the disadvantages.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings.

FIG. 1 shows a diagram of an embodiment of the system for facilitating the discovery and acquisition of micro-credentials via a browser extension.

FIG. 2 shows a diagram including a secondary platform of an embodiment of the system for facilitating the discovery and acquisition of micro-credentials via a browser extension.

FIG. 3 shows a browser extension installed on a user computing device of an embodiment of the system for facilitating the discovery and acquisition of micro-credentials via a browser extension.

FIG. 4 shows another browser extension installed on a user computing device of an embodiment of the system for facilitating the discovery and acquisition of micro-credentials via a browser extension.

### DETAILED DESCRIPTION OF THE INVENTION

Reference is made herein to the attached drawings. For the purpose of presenting a brief and clear description of the present invention, the preferred embodiment will be discussed as used for discovering and acquiring a micro-credential via a browser extension. The figures are intended for representative purposes only and should not be considered to be limiting in any respect.

As used herein, “computer-readable medium” or “memory” excludes any transitory signals, but includes any non-transitory data storage circuitry, e.g., buffers, cache, and queues, within transceivers of transitory signals. As used herein, “logic” refers to (i) logic implemented as computer instructions and/or data within one or more computer processes and/or (ii) logic implemented in electronic circuitry. References to “display” or “display screen” include any electronic device, such as a computer or tablet having an interactive touchscreen.

Reference will now be made in detail to the exemplary embodiment(s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment” does not necessarily refer to the same embodiment. A “micro-credential” as defined herein refers to a digital certification that verifies competence of a skill or set of skills. A “badge” or “digital badge” are used interchangeably and refer to a visual representation of a micro-credential.

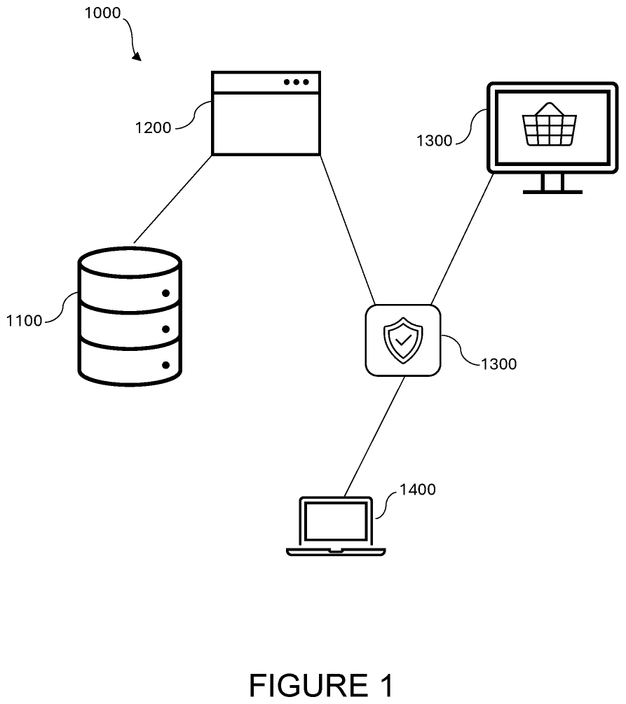

Referring now to FIGS. 1, there is shown a block diagram of an embodiment of the system for facilitating the discovery and acquisition of micro-credentials via a browser extension. The browser extension is configured to be installed through any suitable web browser. The browser extension is further adapted to run through a mobile device application operably connected to a web browser. The system 1000 is configured to facilitate the discovery, engagement, and acquisition of digital micro-credentials through an integration with web browsers via a browser extension. The system 1000 addresses technical challenges associated with the fragmented nature of digital learning and credentialing opportunities by providing a unified platform for identifying, engaging with, and validating such opportunities across the internet.

In the illustrated embodiment, the system 1000 comprises a server 1100 having processing capabilities and memory storage, wherein a logic is operably connected thereto. The server 1100 is adapted to host a website 1200 having a Uniform Resource Locator (URL). The system 1000 further comprises a micro-credential browser extension 1300 that is accessible within a web browser environment of a user computing device 1400. The micro-credential browser extension is received via a digital store or marketplace 1300 and configured to interact with the website 1200 accessed through the user computing device 1400. In the illustrated embodiment, the user computing device 1400 is a computer. However, in alternate embodiments, the user computing device is any suitable device capable of running a browser extension, such as a mobile electronic device. The user computing device 1400 is configured to receive input from a user via a graphical user interface or other interface.

Once installed on the user computing device 1400, the micro-credential browser extension 1300 is configured to automatically search for and detect a micro-credential earning opportunity. In the illustrated embodiment, the micro-credential communicates with the server 1100, searching a data store for a URL that matches the current URL loaded in a browser for a micro-credential that is unique to the URL. Upon identifying a relevant micro-credential opportunity, the system 1000 generates a user notification within the browser of the user computing device 1400. This notification not only alerts the user to the opportunity but also delineates the actions or criteria required for earning the micro-credential. The extension 1300 is equipped with functionalities to monitor user interactions with the web page, verifying the completion of specified criteria. This monitoring and verification process employs advanced data capture and analysis techniques, solving the technical issue of accurately tracking and validating diverse user actions in varied web environments.

In the illustrated embodiment, the logic of the server when executed performs a method for earning a micro-credential via a micro-credential browser extension. The method for earning a micro-credential via the micro-credential browser extension comprises searching a data store for a URL that matches the current URL loaded in a browser for a micro-credential that is unique to browser. In some embodiments, the data store is disposed within the server 1100, whereas in alternate embodiments, the data store is loaded onto the user computing device 1400 when the micro-credential browser extension is received by the user computing device.

Each micro-credential is linked to a distinct criterion from a set of criteria for earning the micro-credential. In the illustrated embodiment, each criterion is adapted to be executed and detected by the micro-credential browser extension, when the website URL is simultaneously detected by the micro-credential browser extension. The criteria include but are not limited to visiting a URL, answering a list of questions related to material provided on the URL, watching a video on the URL, taking a course, etc. The system is configured to detect the user performance of the criteria and upon completion of the criteria issues a badge to the user certifying the completion of the micro-credential.

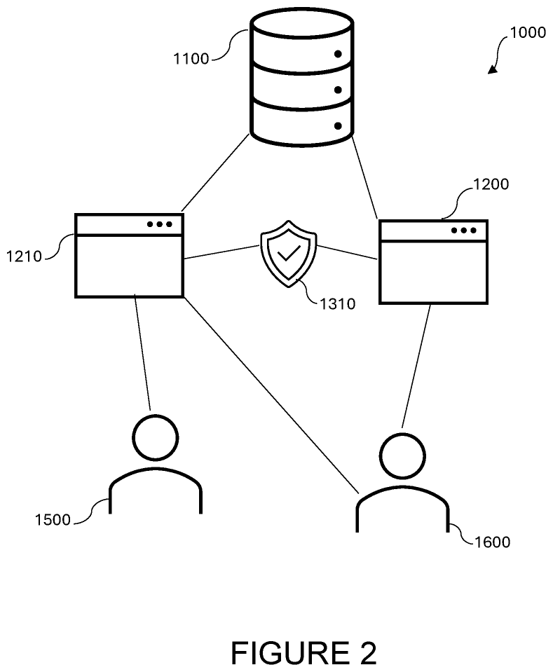

Referring now to FIG. 2, there is shown diagram including a secondary platform of an embodiment of the system for facilitating the discovery and acquisition of micro-credentials via a browser extension. In the illustrated embodiment, the micro-credential for each micro-credential browser extension is created by an issuer 1500 on a secondary platform 1210 or secondary website. The secondary platform 1210 serves a role in the creation, dissemination, and management of digital micro-credentials or badges. The secondary platform 1210 is configured to be used by an issuer 1500 aiming to leverage the internet as an expansive learning platform, wherein the issuer is a person or organization requiring or providing an option for a user to earn a micro-credential.

The secondary platform 1210 provides an issuer with a plurality of tools that facilitates the process of badge creation. The tools allow for the establishment of specific criteria for earning badges, encompassing a broad spectrum of activities. These activities can range from straightforward tasks, such as visiting designated webpages, to more complex undertakings like completing educational courses or answering quizzes tied to the content on specific webpages. In the illustrated embodiment, the secondary platform is adapted to allow an issuer to make badges universally accessible to all users 1600 or to limit access to specified groups of learners or users. This flexibility ensures that learning opportunities can be tailored to meet the needs of diverse audiences, from open communities to specialized cohorts.

In some embodiments, the secondary platform 1210 incorporates a badge library, which is a central repository that catalogues all the badges that have been created by a single issuer or all of the issuers allowing public access to each badge created. This library not only serves as a digital archive but also functions as a discovery portal for users 1600. It allows a user 1600 to explore available badges 1310 and identify learning opportunities that align with their interests or professional aspirations. This dual role of the badge library enhances user engagement with educational content across various domains.

In some embodiments, the secondary platform comprises a unified repository where a user can consolidate badges earned from various sources, including those acquired directly through the micro-credential browser extension or from external Learning Management Systems. This consolidation of digital credentials into a single repository facilitates a comprehensive showcase of a user's learning achievements and skills. In the shown embodiment, the micro-credential browser extension is designed to operate in concert with the secondary platform 1210. It dynamically scans and analyzes web content as a user navigates the internet, identifying potential learning opportunities based on the criteria and badges delineated on the secondary platform.

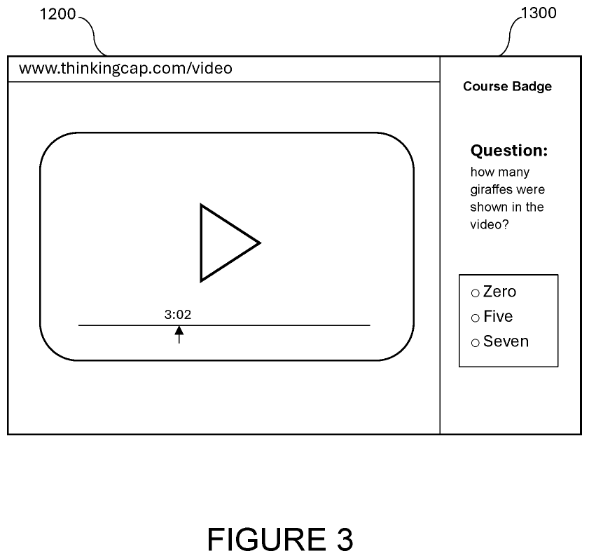

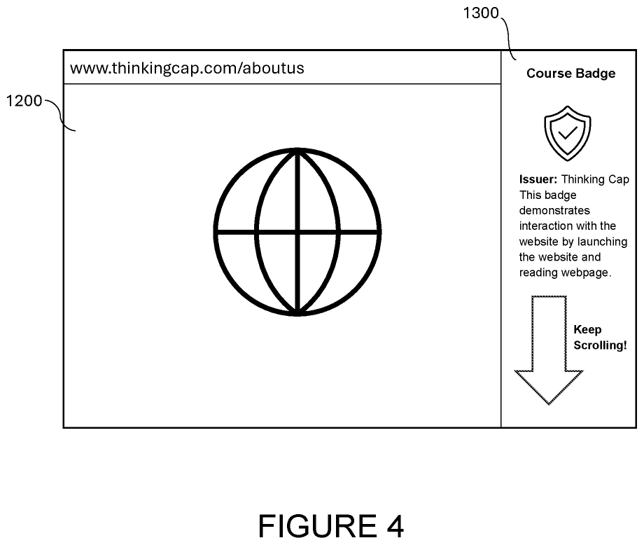

Referring now to FIGS. 3 and 4, there are shown browser extensions installed on a user computing device of an embodiment of the system for facilitating the discovery and acquisition of micro-credentials via a browser extension. The system for micro-credential opportunity discovery and earning via browser extension allows an issuer to create micro-credential earning opportunities on any website via a micro-credential browser extension. The micro-credential browser extension 1300 alerts a user on the website 1200 having a micro-credential earning opportunity of the existence of the micro-credential earning opportunity as soon as the user lands on the website. In the illustrated embodiment, one or more badges will be displayed on an extension sidebar to allow the user to choose a badge to be earned and learn the criteria required to earn the badge. For example, the extension is adapted to scan an article content and URL or a currently accessed website 1200, cross-referencing the data repository to detect an associated micro-credential opportunity. Upon identification, the extension alerts the user via an interactive interface, outlining the steps needed to earn the micro-credential, such as reading the article, completing an associated quiz, and submitting feedback. The user follows the outlined steps, during which the extension actively monitors the user's engagement and interactions with the content. The system will automatically detect once the user has met the criteria and award the badge. Upon fulfilling the specified criteria, the system proceeds with the digital badge issuance, updating the centralized database with the user's newly earned credential. In some embodiments, the system will automatically or when prompted, notify an issuer or other interested entity when the micro-credential or badge has been earned.

The system is configured to interact with the website 1200 to determine if criteria has been met. If criteria has not been met, the system will notify the user through the micro-credential browser extension 1300. In the illustrated embodiment shown in FIG. 3, the notification is shown by displaying a quiz to be completed. In FIG. 4, the user has not completed the criteria required of reading the website because the browser extension has not detected that the user has scrolled to the bottom of the displayed webpage. As a result, the browser extension will not display a test requirement and/or will display further instruction to the user, such as display a notification to continue scrolling the webpage in a particular direction. In alternate embodiments, the systems is adapted to interact with the webpage in any suitable manner to verify if criteria has been technically met.

The micro-credential browser extension allows the issuer to set up educational or non-educational tasks or criteria on any website. For example, in one embodiment, the criteria for earning a badge include a task of answering a set of questions added to a Wikipedia page by a teacher or an employer sending new hires to multiple webpages as part of the employment onboarding experience. The micro-credential browser extension is adapted to be used by any issuer that wants to use the Internet as a learning platform. Badges can be set to be available to the public or to a named group of users. When a badge is created on a secondary website, the issuer can determine how the user must earn the badge, which can be as easy as visiting a webpage or can include more complex tasks or criteria such as answering questions correctly or even taking a short course that is directly related to material on the webpage or website.

In some embodiments, the system is optimized for certain websites, so the micro-credential learning opportunities of websites are more intertwined with other features existing on the website. For example, a micro-credential browser extension on a YouTube™ video can have questions set to appear at certain times during a video playback. This invention allows people to earn rewards and credentials as they are answering questions throughout the internet and the sites the individual is visiting. Certifying a user in training and allowing people to be recognized as brand ambassadors and receiving recognition. Over time additional interaction types specific to certain websites will be added as ways to earn badges from inside the Extension.

The micro-credential browser extension represents a technical development, functioning within the browser environment to scan and analyze content and URLs of accessed web pages. This analysis is performed in real-time, leveraging algorithms to compare the current page's URL with a comprehensive data repository. This repository, which may be hosted locally or on a remote server, maps URLs to specific micro-credentials and their associated earning criteria. This dynamic scanning and matching process addresses the technical challenge of real-time data analysis and retrieval in a fragmented digital landscape.

The system for micro-credential opportunity discovery and earning via a browser extension introduces a technical solution to the fragmented nature of digital learning opportunities and credential verification. By leveraging real-time web page analysis, dynamic user notification, and secure credential issuance mechanisms, the invention overcomes significant technical challenges in the digital education and credentialing domain. This system not only enhances the accessibility and verifiability of learning opportunities but also contributes to the broader objective of promoting lifelong learning and professional development.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A system for facilitating the discovery and acquisition of micro-credentials via a browser extension, comprising:
a server having a logic operably connected thereto, wherein the server adapted to host a website having a Uniform Resource Locator (URL);
a micro-credential browser extension within a web browser environment, where the micro-credential browser extension is configured to interact with the website accessed through a user computing device and based on the URL;
wherein the logic performs a method for earning a micro-credential via the micro-credential browser extension, the method comprising;
searching the currently accessed website for an embedded micro-credential earning opportunity, via a comparison between the URL of the website and a pre-populated database within the system that correlates a URL with at least one micro-credential earning opportunity, wherein each micro-credential is linked to a distinct criterion from a set of criteria for earning the micro-credential;
generating and displaying a notification within the web browser upon detection of the micro-credential earning opportunity;
monitoring actions received from the user computing device within the website to confirm completion of at least one criteria required for the micro-credential;
issuing a digital badge to a user's digital portfolio upon verified completion of the micro-credential.

2. The system of claim 1, wherein the method further comprises displaying a test on a screen of the user computing device upon detection of at least one criteria completion.

3. The system of claim 2, wherein the method further comprises displaying a prompt through the micro-credential browser extension indicating to the user computing device at least one of the criteria to be completed prior to displaying the test.

4. The system of claim 1, wherein the method further comprises sending the digital badge to an issuer of the digital badge.

5. The system of claim 1, wherein the method further comprises receiving a user request to install the micro-credential browser extension on the user computing device and installing the micro-credential browser extension on a browser of the user computing device.

6. The system of claim 5, wherein the method further comprises determining the compatibility of the browser extension with the browser version and the user computing device and retrieving the browser extension from a remote server based on the compatibility determination.

7. The system of claim 1, wherein the method further comprises analyzing user data and preferences to recommend a second URL having a second micro-credential earning opportunity.

8. The system of claim 1, further comprising a secondary platform, wherein the digital badge is created thereon and defines the set of criteria for awarding the digital badge to a user.

9. The system of claim 1, wherein the method further comprises recognizing the criteria directly in the extension and on the user computing device, wherein actions received via the user computing device are tracked by the extension.

10. A computer-implemented method for enhancing discovery and acquisition of digital micro-credentials via a web browser, the method comprising:
providing a system having a server with a logic operably connected thereto and a micro-credential browser extension within a web browser environment, wherein the server adapted to host a website having a Uniform Resource Locator (URL) and the micro-credential browser extension is configured to interact with the website accessed through a user computing device and based on the URL;
searching the currently accessed website for an embedded micro-credential earning opportunity, via a comparison between the URL of the website and a pre-populated database within the system that correlates a URL with at least one micro-credential earning opportunity, wherein each micro-credential is linked to distinct criterion from a set of criteria for earning the micro-credential;
generating and displaying a notification within the web browser upon detection of the micro-credential earning opportunity;
monitoring actions received from the user computing device within the website to confirm completion of at least one criteria required for the micro-credential;
issuing a digital badge to a user's digital portfolio upon verified completion of the micro-credential.

11. The system of claim 10, wherein the method further comprises displaying a test on a screen of the user computing device upon detection of at least one criteria completion.

12. The system of claim 11, wherein the method further comprises displaying a prompt through the micro-credential browser extension indicating to the user computing device at least one of the criteria to be completed prior to displaying the test.

13. The system of claim 10, wherein the method further comprises sending the digital badge to an issuer of the digital badge.

14. The system of claim 10, wherein the method further comprises receiving a user request to install the micro-credential browser extension on the user computing device and installing the micro-credential browser extension on a browser of the user computing device.

15. The system of claim 10, wherein the method further comprises automatically updating the installed browser extension to ensure it remains compatible with the user computing device.

16. The system of claim 10, wherein the method further comprises recognizing the criteria directly in the extension and on the user computing device, wherein actions received via the user computing device are tracked by the extension.

17. The system of claim 10, wherein the system further comprises a secondary platform, wherein the digital badge is created thereon and defines the set of criteria for awarding the digital badge to a user.
